(19) United States
(12) Patent Application Publication
(10) Pub. No.: US 2009/0249637 A1
(43) Pub. Date: Oct. 8, 2009

(54) APPARATUS FOR COOLING BULK MATERIAL

(75) Inventors: Peter Ording, Bremen (DE); Sprinz Uwe, Harsefeld (DE)

Correspondence Address: MORRISON & FOERSTER LLP, 1650 TYSONS BOULEVARD, SUITE 400, MCLEAN, VA, 22102, US

(73) Assignee: Claudius Peters Technologies GmbH, Buxtehude (DE)

(21) Appl. No.: 12/374,256

(22) PCT Filed: Jul. 10, 2007
(86) PCT No.: PCT/EP07/06103

§ 371 Date: Jan. 16, 2009

(30) Foreign Application Priority Data
Jul. 20, 2006 (EP) 06015148.7

(51) Int. Cl. F26B 17/02

(52) U.S. Cl. 34/181

(57) ABSTRACT

An apparatus for cooling bulk material, comprising a grate having a device to feed cooling gas, conveying elements configured to convey a layer of the bulk material along a conveying direction, and a planar blowout device. The grate forms a substantially smooth supporting surface for the layer of the bulk material. The supporting surface is provided at least partially with the planar blowout device. The planar blowout device has a fabric as a spatially extended dispersion element on which the bulk material directly rests, and a support structure arranged under the fabric. Webs arranged transverse to the conveying direction can result in pockets that enable a stationary layer composed of cooling material to be located above the dispersion elements.

### REFERENCE TO RELATED APPLICATIONS

This application is a national stage application under 35 USC 371 of International Application No. PCT/EP2007/006103, filed Jul. 10, 2007, which claims priority of European Patent Application No. 06 015 148.7, filed Jul. 20, 2006, the contents of which are incorporated herein by reference in their entirety.

### FIELD OF THE INVENTION

The invention relates to an apparatus for cooling bulk material, having a grate that has a device for feeding cooling gas and conveys a layer of the bulk material along a conveying direction, the grate comprising conveying elements and forming a substantially smooth supporting surface for the layer of the bulk material.

### BACKGROUND OF THE INVENTION

Apparatuses of the type mentioned in the beginning serve as grate coolers, particularly for cooling burnt material, for example for cement clinker exiting from an upstream furnace. The bulk material discharged from the upstream work station, as a rule from the furnace, is transported along the cooling grate to the down-stream work station and cooled down in the process. In order to cool the bulk material located on the grate, the grate cooler has a feed for cooling gas. This is generally performed by blowing in cooling gas through the grate such that said gas enters the bulk material to be cooled from below, flows through it and leaves it at the top. Difficulties frequently occur in feeding cooling gas from the fact that parts of the grate are of moveable design so as to effect conveyance of the bulk material along the cooling grate. A complicated guidance of the cooling gas through the cooling gas device results therefrom and from the goal of feeding cooling gas as uniformly as possible. This results in pressure losses that increase the energy requirement of the cooling device. A further difficulty consists in that in some designs of the cooling apparatuses there is a need for conveying elements that serve to effect the conveyance of the bulk material to be led moveably through the grate surface from below, and this complicates the design. In addition, the conveying elements inside the hot layer of the bulk material are exposed to high wear for which purpose they have to be of greater dimension in order to achieve sufficient operational reliability and service life. However, the air throughput for the cooling gas is reduced, and the cooling effect is thereby limited, in those regions of the cooling grate in which the conveying elements and their drive devices are located. It has emerged that even in the case of a modern cooling grate (DE-U-202004020574) an undesired high flow resistance still does come about, particularly in the region of the exit of the cooling gas, and the distribution of the cooling gas over the grate surface is nonuniform. A remedy is not possible via simply enlarging the exit surface for the cooling gas, since this would cause bulk material to fall through into the space beneath the grate, the consequence being damage to the conveying elements.

### SUMMARY OF THE INVENTION

It is the object of the invention to proceed from the above prior art and produce an improved cooling grate that avoids said disadvantages.

The inventive solution is a cooling grate having features as broadly described herein. Advantageous developments are the subject matter of the embodiments described below.

In the case of an apparatus for cooling bulk material, having a grate that has a device for feeding cooling gas and conveys a layer of the bulk material along a conveying direction, the grate comprising conveying elements and forming a substantially smooth supporting surface for the layer of the bulk material, the invention provides that the supporting surface is provided at least partially with a planar blowout device that has a fabric as spatially extended dispersion element on which the bulk material directly rests, and a support structure arranged thereunder.

The invention is based on the idea of using the dispersion element and the support structure arranged directly thereunder to produce a composite structure that, on the one hand, provides a large exit surface for the cooling gas and, on the other hand, is sufficiently robust to support the layer of the bulk material to be cooled which rests thereon. Here, the fabric provides a multiplicity of small passage channels for the cooling gas. Depending on whether the aim is to obtain a more or less fine dispersion, the fabric can consist of nonwoven material or of metallic material (wire fabric). Because of its structure, on the one hand it provides a large surface for the cooling gas passage and, on the hand, because of the smallness of the channels (or meshes or pores) conducting the cooling gas, it prevents the fall through the grate, that is to say prevents bulk material to be cooled from falling through into the space beneath the grate. Small means a width of the channels that is substantially smaller than particles of the bulk material. The support structure has the effect of lending sufficient mechanical stability and load-carrying capacity to the inherently insufficiently stable fabric. In addition to the described mechanical effect of the invention, because of the better air distribution through the fabric the invention on the one hand further achieves an improved heat exchange of the cooling and thus lower energy costs, and on the other hand achieves a reduction in pressure losses produced upon entry of the cooling gas by comparison with known designs of cooling grates to such an extent that further substantial energy savings can be attained.

DE-A-2 345 734 discloses a cooling grate in the case of which the supporting surface is constructed as a perforated plate on which a layer of the bulk material to be cooled rests, and on whose underside a fabric material is arranged. The fabric material can function as dispersion element for cooling gas fed from below. The perforated plate arranged above the fabric material protects the fabric material against wear. Through the perforated plate arranged above the fabric as support, this design certainly achieves a good protection of the fabric material against wear, but there is a substantial increase in the flow resistance owing to the openings that have to be provided in the perforated plate for the passage of the cooling gas. The efficiency of the cooling is thereby impaired. A further disadvantage of the supporting element arranged above the fabric, specifically the perforated plate, is that material from the layer of the bulk material to be cooled can fall into the openings of the perforated plate, and thereby block the latter, or at least prevent the passage of the cooling gas. This design therefore proves to be in great need of improvement precisely under the rugged operating conditions of a clinker cooler.

A particular advantage of the arrangement of the support structure directly under the fabric as dispersion element is that reliable mechanical support is thereby achieved. By virtue of the invention, instances of sagging or indentation under the loading of the weight force of the resting layer of the bulk material to be cooled no longer occur. It follows that it is possible by virtue of the invention to reduce the loading of the dispersion element. This enables not only the use of thinner material, such as the inherently sensitive fabric material, for the dispersion element, but also reduces the damage susceptibility of the device.

It is expedient to provide a trough in which the support structure and on the edge of which the dispersion element are arranged, the trough having a feed connection for the cooling gas on the bottom side. With such a trough, a dedicated structural unit is provided that can be produced, and mounted, separately from the grate. This enables a more simple and efficient production. It is expedient to design the composite structure of dispersion element and support structure as an exchangeable module. This enables the provision of standardized modules that still need to be inserted only at appropriately prepared receiving locations of the grate. Production and mounting are thereby substantially facilitated. Furthermore, the design as module enables an exchange to be undertaken easily in case of need.

In one design as module, it is expedient to provide a matrix arrangement. In particular, it has proved effective, in the case of cooling grates in accordance with the walking floor principle with a number of planks that can be displaced longitudinally in parallel next to one another in the conveying direction and are moved forward and backward alternately, to arrange a number of modules one behind another in the conveying direction.

In a particularly expedient embodiment, webs projecting into the bulk material are arranged transverse to the conveying direction. The webs form a region in which the bulk material resting directly on the dispersion element does not move, or moves only scarcely, up to a certain layer thickness influenced by the web height. This part of the bulk material layer is thus virtually at rest with reference to the dispersion element. It therefore forms a further protection, occurring automatically in operation, against wear by the bulk material to be cooled. Thus, the lowermost layer of the bulk material to be cooled, which lies in a quasi stationary fashion relative to the respective element of the grate owing to the webs arranged transverse to the conveying direction, protects the dispersion element against wear by the remaining principal quantity of the bulk material, which is frequently aggressive in terms of wear owing to its abrasive components.

Furthermore, it is expedient to provide a material sump in the supporting grid in a fashion parallel to the conveying direction and to the side of the dispersion element. It serves the purpose of offering a collecting space for components of the bulk material, in particular fine dust components, migrating downward from the layer of the bulk material to be conveyed. It has emerged that it could otherwise come about that the downwardly migrating fine components could choke the dispersion element. As a result of the material sump, this material accumulates in the space produced by the material sump. Consequently, the dispersion element can be protected against choking and, if appropriate, small residues of fine components still landing on it can be discharged thanks to the cooling gas flow guided through the dispersion element. The material sump can be formed with any desired cross section per se, in particular it can be a square, rectangular or else a round design.

It can preferably be provided that the dispersion element is constructed in a fashion spreading over a number of bordering modules. Spreading is understood here to mean that a uniform piece of the dispersion element spans the region of a number of the support structures bordering one another in the conveying direction, in particular. Abutting edges between the dispersion elements and sealing problems possibly resulting therefrom are thereby avoided. Moreover, the outlay for the production is reduced, and the maintenance is accordingly facilitated in the event of an exchange of the dispersion element possibly becoming necessary. The support structures can be arranged in this case at a certain spacing from one another, but it is more expedient to arrange them in a fashion directly mutually bordering one another. This enables a maximum extent of the surface used to blow out cooling gas.

The support structure is preferably formed from a number of plate elements arranged in a cross connected fashion. This enables an economical and at the same time mechanically stable design of the support structure as supporting grid. The plate elements can be provided with slit-like cutouts in accordance with the width of the supporting grid, in order to enable the plate elements to be plugged together to form the support structure. This permits a particularly simple production. The plate elements are expediently constructed in this case such that they are of the same shape. It can further be provided that they are of the same length, but this is not mandatory. A substantial reduction in the multiplicity of parts, and thus a simplified production, can already be achieved by designing the plate elements for the support structure to be the same shape.

It is possible in principle for the inventive composite structure of dispersion element and support structure to be arranged in a fixed part or a moveable part of the cooling grate. It is also possible to provide a combined arrangement. A particular advantage of the inventive design resides, however, in the fact that because of its simplicity and, in particular, its modular design, it is suitable for arrangement in a moveable element of cooling grates. In this case, the dispersion surface can be arranged such that it is positioned between the remaining space for conveying elements for the layer of the bulk material to be cooled. Consequently, the use of the inventive cooling grate is also enabled in the case of combustion material coolers such as those which have conveying elements that are separate (and not, as in the case of the walking floor principle, integrated in the actual grate).

It is expedient for the dispersion element to be produced such that its grid width is less than 1 mm. Grid width is to be understood here as the width of a channel for feeding cooling gas and which leads through the dispersion element. This width can be used to achieve sufficient reliability against an undesired charging of bulk material without an unnecessarily high pressure loss thereby occurring with reference to bulk material that penetrates or falls through.

### BRIEF DESCRIPTION OF THE DRAWINGS

The invention is explained below with reference to the attached drawing, in which an advantageous exemplary embodiment is pictured, and in which:

FIG. 1 shows a schematic longitudinal section through a cooler in accordance with the invention;

FIG. 2 shows a partial cross section of a cooler in accordance with a first embodiment;

FIG. 3 shows a partial plan view of the cooler illustrated in FIG. 2;

FIG. 4 shows a partial cross section of a cooler in accordance with a second embodiment;

FIG. 5 shows a cross section of a dispersion element of a cooler in accordance with a third embodiment;

FIG. 6 shows a plan view of the dispersion element illustrated in FIG. 5;

FIG. 7 shows a cross section of a plank of the grate in accordance with a fourth embodiment;

FIG. 8 shows a perspective partial view of the plank illustrated in accordance with FIG. 7;

FIG. 9 shows a perspective partial view of a cooler in accordance with a fifth embodiment;

FIG. 10 shows a partial cross section of the embodiment illustrated in FIG. 9;

FIG. 11 shows a partial cross section of a cooler with separate conveying elements and two different designs of the dispersion elements in accordance with a sixth embodiment;

FIG. 12 shows a partial cross section of a cooler in accordance with a seventh embodiment;

FIG. 13 shows a partial cross section of a cooler in accordance with an eighth embodiment; and

FIG. 14 shows a partial cross section of a cooler in accordance with a combination from the embodiments illustrated in FIGS. 11 and 12.

### DETAILED DESCRIPTION OF THE INVENTION

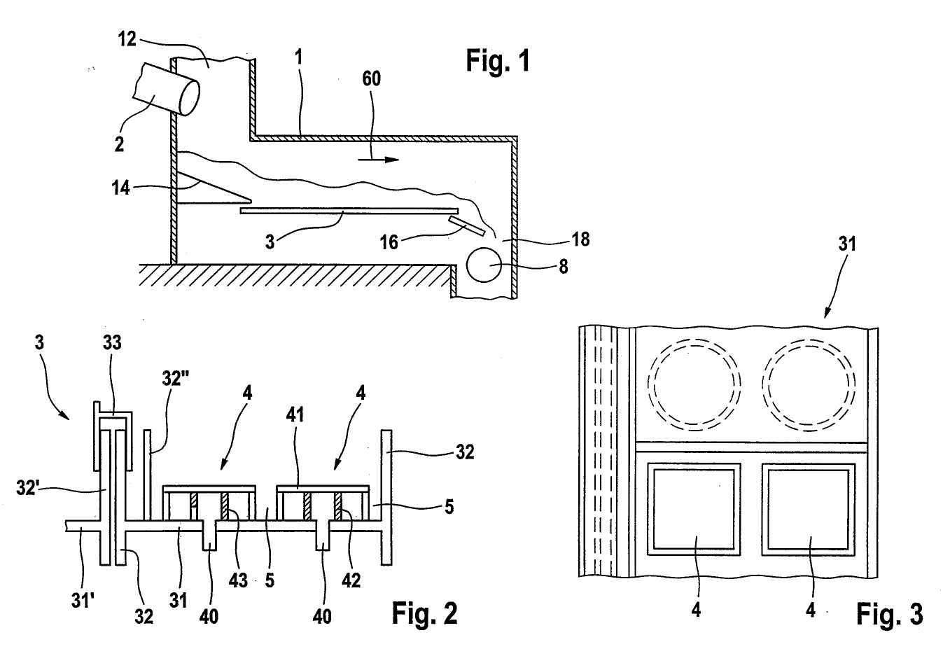

A schematic exemplary embodiment of inventive coolers is illustrated in FIG. 1. A housing 1 has at one end a charger shaft 12 in which a discharge end of a rotary tubular kiln 2 opens. Bulk material to be cooled which is discharged by the rotary tubular kiln 2 and is subsequently denoted as cooling material falls in the charger shaft 12 onto a charger section 14 of the cooler, and passes from there onto an inventively designed grate 3. The latter is substantially of horizontal construction and forms a supporting and transporting surface for the cooling material. The cooling material lying on the grate 3 is fed cooling gas from below through the grate 3. The material is transported to a discharge end 16 along the grate 3 in a conveying direction 60 by means of a conveying device. The cooling material then falls via an optionally arranged discharge section 18 to a downstream processing stage, for example to a breaker 8.

It is provided in the first exemplary embodiment that the grate 3 is formed from a plurality of planks 31 arranged in parallel in the conveying direction 60. The planks can be moved forward and backward individually and are driven by a movement control device such that they are pushed forward jointly and moved back individually. This conveying principle for cooling grates is known under the designation “walking floor” (DE-A-19651741); it is therefore possible to dispense with explaining details relating to design and mode of operation. A cross-sectional view through a plank 31 of the grate 3 is illustrated in FIG. 2. The plank 31 has elevated cheeks 32 at its lateral edges facing the neighboring planks 31′. The two cheeks 32 of a plank 31 form lateral boundaries of a hollow. A sealing profile 33 spread over the other ends of the cheeks 32, 32′ is provided in order to protect against undesired penetration of cooling material into the interspace between neighboring cheeks 32, 32′. As an option, a delimiting cheek 32′ is arranged next to the cheek 32 on the side of the plank 31 facing the sealing profile 33. This ensures that fine particles of the bulk material that are produced by the relative movement between the individual planks cannot reach the dispersion element.

The plank 31 forms a supporting surface for the cooling material with its upper side. Arranged on the underside of the planks 31 are feed devices (not illustrated) for cooling gas, and these are used to feed cooling gas to the planks 31. The planks 31 have connecting pieces 40 on their underside for the purpose of connecting the feed devices.

There are provided on the top side of the plank blowout devices 4 designed in accordance with the invention to which the cooling gas is fed from the connecting pieces 40 through the planks 31. The design of one of the blowout devices 4 is explained in more detail below. It is generally of box-type shape. The top side is of two-layered design with a dispersion element, extended in planar fashion, and a supporting element. The dispersion element is formed by a metal fabric 41 in this embodiment. It spans the entire top side of the blowout device 4. It lies on a support structure 42 that is designed as a supporting grid and supports the metal fabric 41 from below. The supporting grid 42 is formed from a plurality of plate-type segments 43 that are joined in a cross connected fashion. The upper edges of the segments 43 are in one plane and form a support for the metal fabric 41. The result of this is that the metal fabric 41 is not deformed or damaged even under the weight of a resting layer of cooling material. The cooling gas fed via the connecting pieces 40 is distributed between the segments 43 of the supporting grid 42 such that it is fed to the metal fabric 41 from below. It flows through the metal fabric 41, being finely distributed in the process and entering the resting material layer from the metal fabric 41 over a large area. This results in the cooling gas passing over into the cooling material both over a large area and uniformly. The low cooling gas speeds thereby obtained cause a low pressure loss, on the one hand, and an optimum cooling of the cooling material, on the other hand. These two together enable a low energy requirement. The metal fabric 41 is a sufficiently fine mesh in this case to prevent cooling material falling undesirably through the metal fabric 41.

In order to further counteract the risk of the cooling material choking the blowout device 4, a material sump 5 can be provided between the blowout devices 4. It serves the purpose of providing a receiving space for cooling material that falls through. The risk of choking of the metal fabric 41 is thereby reduced further.

As shown by the plan view in FIG. 3, the blowout device 4 can also have a contour other than a box-type one. The above-described embodiment of the blowout device 4 is illustrated in the lower area of FIG. 3 by continuous lines. The upper area of FIG. 3 illustrates a variant in the case of which the blowout device has a cylindrical contour. The above statements are valid for this design mutatis mutandis.

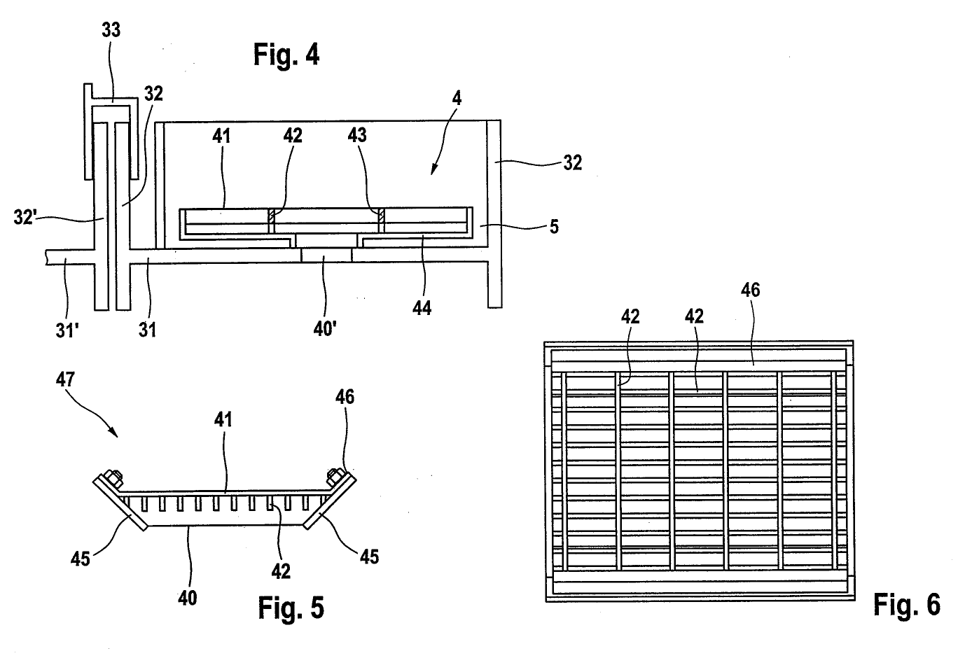

In a second embodiment of the invention, which is illustrated in FIG. 4, the blowout device 4 is designed in the shape of a basin 44 that extends virtually over the entire width of the plank 31. By comparison with the embodiment illustrated in FIGS. 2 and 3, this embodiment results in enlargement of the surface available for the exit of the cooling gas. Consequently, there is a yet better and, above all, uniform cooling.

A material sump 5 can be provided in the case of this embodiment, as well. It is arranged at the long sides of the basin 44′ and extends partially under the bottom of the basin 44. For the purpose of feeding the cooling gas, a central connecting piece 40 is provided in the bottom of the basin 44, or it is provided that cooling gas flow directly on over the entire width.

A third embodiment of the invention is illustrated in FIGS. 5 and 6. The blowout devices are of modular design in this embodiment. FIG. 5 shows a cross section through such a module, which is provided in its entirety with the reference numeral 47. It comprises a trough 45 with optionally inclined edges at which the metal fabric 41 is clamped in by means of edge strips 46. The edge strips 46 are fastened in the exemplary embodiment illustrated by being screwed at the edge of the trough 45; however, it is also possible to provide another type of fastening that offers an adequately reliable fastening. The support structure 42 is arranged directly under the metal fabric 41. It is constructed such that its lower edge is designed along its outer sides with an inclination corresponding to that of the edges of the trough 45. The supporting grid 42 can thus be inserted into the trough 45 in a self-centering fashion. The metal fabric 41 is laid onto the support structure 42 and fastened by means of the edge strips 46. The bottom of the trough 45 has an opening of large area for feeding cooling gas. The module 47 therefore only need be inserted at its place the element of the grate 3 intended for receiving it, as a result of which it is centered in its receiving position automatically thanks to the inclined edges 46, and the connection is made to the cooling gas feed taking place from below. As a rule, its own weight and that of the resting cooling material provide adequately reliable blocking, but it is also possible if desired to provide separate fastening elements (not illustrated) for greater fastening reliability. A plan view of a module 47 is illustrated in FIG. 6.

FIGS. 7 and 8 show an alternative embodiment in the case of which a web 34 projecting into the cooling material is arranged to the rear of the blowout device 4 when seen in the conveying direction 60. It is evident that the blowout devices 4 adjacent in the conveying direction are likewise provided with such a web 34. The webs 34 are expediently arranged along delimiting sides of the dispersion element 41 that are oriented trans-verse to the conveying direction. Consequently, one of the webs 34 is arranged on each of the two delimiting sides of the blowout device 4 that are oriented trans-verse to the conveying direction 60. The webs 34 serve to form on the grate 3 hollows in which cooling material accumulates during operation of the cooler. This accumulation takes place as a layer that is not moved along the conveying direction 60 in normal operation of the cooler, but remains in a quasi stationary fashion with reference to the respective region of the surface of the grate 3; in the case of a walking floor, this layer also moves in accordance with the forward and backward movements of the plank 31. The hollows delimited by the webs 34 thus retain cooling material during operation. They are therefore also designated as “material-holding hollows”. The part of the cooling material arranged in quasi stationary fashion in the respective hollow executes no substantial relative movement in relation to the plank 31. This means that the dispersion element 41′ is not, or is only minimally, loaded by abrasive components of the bulk material. The risk of damaging the dispersion element 41′ is therefore minimized. Consequently, the support structure 42′ can be constructed to reduce the flow resistance further. The supporting grid 42′ is integrated in the surface of the grate 3. Moreover, the quasi stationary material layer located between the webs 34 acts as a filter that does not permit passage of the particles below a specific size. As a result of all this, the dispersion element 41′ can be designed with a comparatively large mesh for example as an industrial wire fabric. This embodiment results in a blowout over a large area that, in addition, can exhibit a high throughput thanks to the large average cross section in this region. A separate connection for the cooling gas is not required at the underside of the blowout device. Cooling gas is supplied by providing the cooling gas with overpressure in the space beneath the grate 3. This produces, in conjunction with a simple design, a blowout device that is protected against wear and operates with low pressure loss.

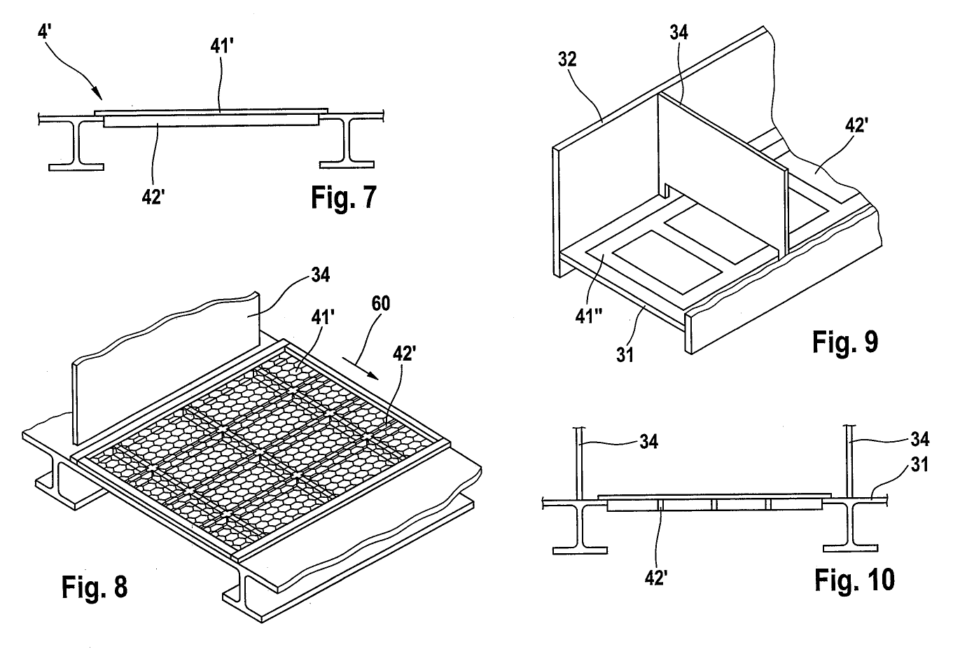

FIGS. 9 and 10 illustrate a modification of the embodiment in accordance with FIG. 3. It differs essentially in that a dispersion element 41″ extends in a longitudinal direction (parallel to the conveying direction 60) over a number of support structures 42′. It is expedient for the support structures 42′ jointly spanned by the dispersion element 41″ to be arranged in a plank 31 if the cooler is one according to the walking floor principle. Abutting edges between mutually bordering dispersion elements 41″ are avoided in this case, as are sealing problems possibly resulting therefrom. In addition, the mounting and the exchange of the dispersion element is simplified, since only one dispersion element 41′ needs to be removed or to be installed. The arrangement of the dispersion element 41″ in a spreading-over fashion in this case offers advantages particularly when the blowout devices 4, specifically the supporting grids 421, in particular, are designed in the modular way explained above.

The blowout devices 4 in accordance with the present invention are not restricted to being applied to moving elements of the grate 3. It can equally be provided for them also, or instead, to be arranged on stationary elements of the grate 3. This holds, in particular, for those combustion material coolers that have conveying elements for the cooling material which are separate from the grate 3.

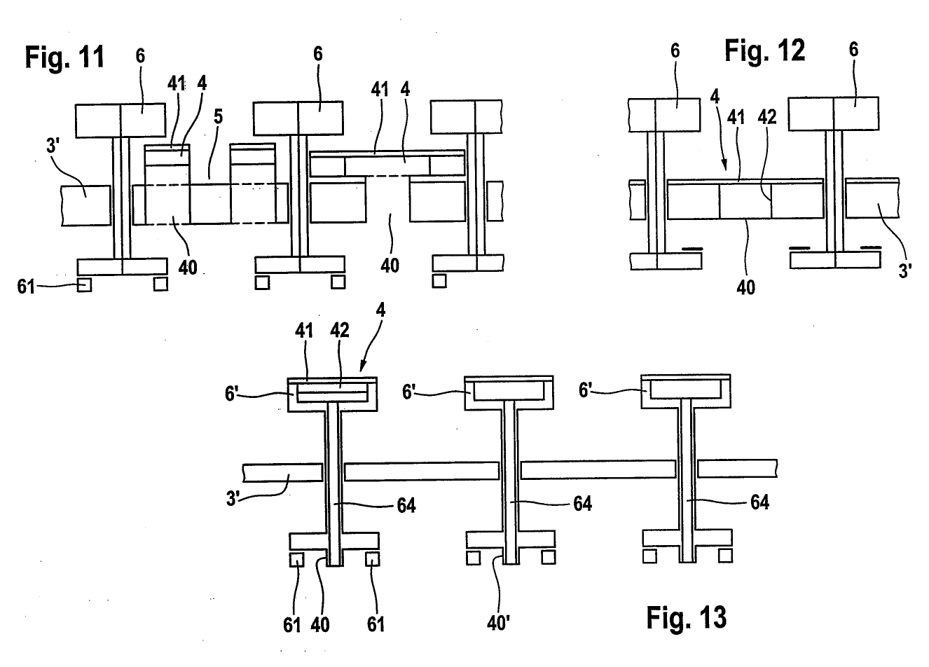

FIGS. 11 and 12 illustrate sixth and seventh embodiments in the case of which the inventive blowout devices 4 are arranged at or between moving separate conveying elements of the grate of the combustion material cooler. In the embodiment in accordance with FIG. 11, a stationary grate 3′ is provided that has a plurality of separate conveying elements 6 arranged next to one another. These are guided in a longitudinally moveable fashion in the grate 3′ in slots running parallel to the conveying direction 60 and moved by a drive device (not illustrated). One (right-hand half of FIG. 11) or a number of (left-hand half of FIG. 11) blowout devices 4 is/are arranged in the interspaces between the conveying elements 6. They can be designed in accordance with one of the above-described embodiments and are arranged such that they project upward out of the surface of the grate 3. As a result, spaces are formed between them that function as material sump 5. In the embodiment in accordance with FIG. 12, the blowout devices are sunk flush into the top side of the grate 3′. This arrangement has the advantage of a uniform surface, the result being to favor a more uniform application of the cooling gas to the cooling material. Moreover, it is possible in the case of this embodiment to maximize the region provided for the blowout devices 4, and thus to maximize the surface active overall in blowing out. A separate material sump is not provided with this embodiment; a more leakproof design of the metal fabric 41 serves to reduce the cooling material that falls through. Because of the large blowout surface, larger flow resistances produced by the more leakproof design do not have a negative effect.

A variant of the embodiments in accordance with FIG. 11 is illustrated in FIG. 13 as eighth embodiment, in the case of which the blowout devices are arranged not on the stationary part of the grate 3′ but on the moveable conveying elements 6′. The design of the blowout devices 4 corresponds to the previous statements. A difference resides in the way the cooling gas is fed. It is fed from below via a connecting piece arranged between longitudinal bearings 61 of the conveying elements 6′, and led to the blowout device 4 arranged at the upper end of the conveying element via a riser 64 integrated in the conveying element 6′. In this embodiment, an uncooled and virtually unmoved layer of the material is produced and rests on the top side of the grate 3′. It does not participate in the processes of cooling and conveying. It forms a type of stationary protective layer of the grate 3′ against wear. Since the temperature of this layer corresponds approximately to that of the grate 31, a cooling of this layer is unnecessary and is also avoided thanks to the raised arrangement of the blowout devices 4 at the upper end of the conveying elements 6′. The result of arranging the blowout devices above on the conveying elements 6′ is that the cooling gas is fed firstly at the lower boundary of the moving cooling material. Losses owing to flow resistances are thereby minimized, and a high efficiency is thus achieved.

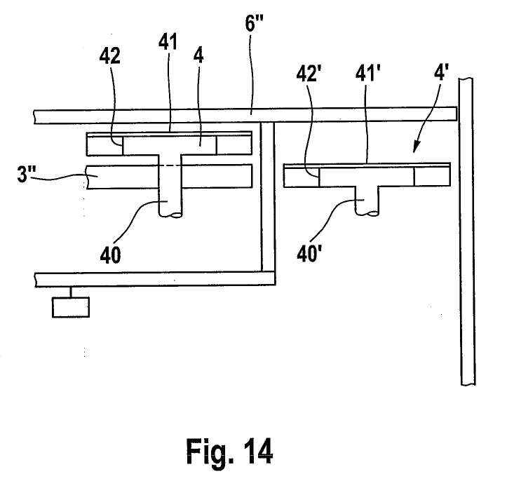

FIG. 14 illustrates a variant as ninth embodiment, which is essentially a combination of the sixth and seventh embodiments. In this embodiment, the conveying elements extend transversely over the entire cooler width. The inventive blowout devices 4 are designed either as separate modules above or as an integrated component of the fixed cooling grate 3″.

1. An apparatus for cooling bulk material, comprising a grate having a device to feed cooling gas, conveying elements configured to convey a layer of the bulk material along a conveying direction and a planar blowout device, the grate forming a substantially smooth supporting surface for the layer of the bulk material, wherein the supporting surface is provided at least partially with the planar blowout device, the planar blowout device having a fabric as a spatially extended dispersion element on which the bulk material directly rests, and a support structure arranged under the fabric.

2. The apparatus of claim 1, wherein a trough is provided in which the support structure and the fabric are arranged, the trough having a feed connection for the cooling gas on the bottom side.

3. The apparatus of claim 1 or 2, wherein the fabric and the support structure are combined to form a module that is arranged exchangeably on the grate.

4. The apparatus of claim 3, wherein a number of the modules are provided in a matrix arrangement.

5. The apparatus of claim 1, wherein webs projecting into the bulk material are arranged transverse to the conveying direction on the grate.

6. The apparatus of claim 1, wherein a material sump is provided to the side of the fabric in the conveying direction.

7. The apparatus of claim 3, wherein the fabric) is constructed such that it spreads over a number of bordering modules.

8. The apparatus of claim 7, wherein the support structures of the mutually bordering modules directly adjoin one another.

9. The apparatus of claim 1, wherein the support structure is configured as a supporting grid.

10. The apparatus of claim 9, wherein the supporting grid is constructed from plate elements arranged in a cross connected fashion.

11. The apparatus of claim 1, wherein the fabric) and the support structure are arranged in a moveable element on the grate.

12. The apparatus of claim 1, wherein the fabric projects from the supporting surface of the grate.

13. The apparatus of claim 5, wherein cheeks oriented in the conveying direction are provided on the grate, and the cheeks together with the webs form material-holding hollows.

14. The apparatus of claim 13, wherein the cheeks are arranged on the long side of planks of the grate.

15. The apparatus of claim 14, wherein an additional cheek is arranged on the inside of a sealing profile of one of the planks.
